(19) United States
(12) Patent Application Publication
(10) Pub. No.: US 2007/0019629 A1
(43) Pub. Date: Jan. 25, 2007

(54) Pushbutton telephone equipment, telephone switching equipment, and accommodating method thereof

(75) Inventor: Hitoshi Kato, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/472,529

(22) Filed: Jun. 22, 2006

(30) Foreign Application Priority Data
Jun. 30, 2005 (JP) 2005-191209

(51) Int. Cl. H04L 12/66

(52) U.S. Cl. 370/352

(57) ABSTRACT

According to one embodiment, a pushbutton telephone apparatus comprising a plurality of interface units for accommodating telephone terminals, wherein the pushbutton telephone apparatus is characterized in including an analyzing unit for analyzing an accommodating state in each of the plurality of interface units, a storing unit for storing, as accommodating number information, the accommodating state analyzed by the analyzing unit, a selecting unit for selecting an interface unit having the smallest accommodating number based on the accommodating number information stored in the storing unit, and an accommodating unit for accommodating the telephone terminals requesting connection in the interface unit selected by the selecting unit.

### CROSS-REFERENCE TO RELATED APPLICATIONS

This application is based upon and claims the benefit of priority from Japanese Patent Application No. 2005-191209, filed Jun. 30, 2005, the entire contents of which are incorporated herein by reference.

### BACKGROUND

1. Field

One embodiment of the invention relates to pushbutton telephone equipment comprising a plurality of interfaces for accommodating, for instance, telephone terminals, and in particular, relates to pushbutton telephone equipment and telephone switching equipment for selecting an interface to accommodate a telephone terminal according to the load imposed by the number of telephone terminals accommodated, and accommodating methods thereof.

2. Description of the Related Art

In recent years, there has been a rise in pushbutton telephone equipment and telephone switching equipment having a function of connecting with VoIP telephone terminals. The pushbutton telephone equipment and telephone switching equipment comprise interface cards exclusively for accommodating the VoIP telephone terminals, and the number of interface substrates is determined according to the number of VoIP telephone terminals to be accommodated. The interface cards can also support IP-QSIG.

The aforementioned pushbutton telephone equipment and telephone switching equipment have the following three methods as means for accommodating the VoIP telephone terminals.

The first method is to designate, by a maintenance terminal, an interface card to accommodate a VoIP telephone terminal according to its extension number.

The second method is to determine the extension number of a VoIP telephone terminal to which connection has been requested and an interface card for accommodating the telephone terminal when the VoIP telephone terminal has requested connection, and not to designate, by a maintenance terminal, an interface card to accommodate the VoIP telephone terminal according to its extension number.

The third method is to automatically determine the extension number of a VoIP telephone terminal and an interface card to accommodate the telephone terminal when the VoIP telephone terminal requests for connection and the extension number of the VoIP telephone terminal has not been set in advance by the maintenance terminal (e.g., Jpn. Pat. Appln. KOKAI Publication No. 2004-336139).

In the first aforementioned method, the interface card to accommodate the telephone terminal must be designated using a separate maintenance terminal. In the second and third methods, the VoIP telephone terminals are accommodated in order starting from the interface card of lowest address. Therefore, there are problems in that the interface cards of smaller numbers are given priority when accommodating the VoIP telephone terminals, and the load is concentrated on those interface cards. Although the interface cards have a function for supporting IP-QSIG, the telephone terminals are accommodated in the interface cards of lower addresses without determining whether or not IP-QSIG is supported by each interface card. Thus, the load becomes even more concentrated when a VoIP telephone terminal is accommodated in an interface card which already supports IP-QSIG.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic block diagram of the structure of the system applied to the pushbutton telephone equipment related to the present invention.

FIG. 2 is a flowchart showing the procedure of analyzing the accommodating state in the interface card of the pushbutton telephone equipment.

FIG. 3 is a flowchart showing the procedure of accommodating the VoIP telephone terminal in the pushbutton telephone equipment when the VoIP telephone terminal requests connection.

FIG. 4 is a schematic diagram showing the priority of the interface card and the analysis results of the accommodating state which are stored in the database of the pushbutton telephone equipment.

FIG. 5 is a schematic block diagram showing the structure of the system applied to the telephone switching equipment related to the present invention.

### DETAILED DESCRIPTION

Various embodiments according to the invention will be described hereinafter with reference to the accompanying drawings. In general, according to one embodiment of the invention, pushbutton telephone equipment comprising a plurality of interface unit for accommodating telephone terminals is characterized in comprising analysis unit for determining the accommodating state in each of the plurality of interface unit, storing unit for storing the accommodating state determined by the analysis unit as accommodating number information, selecting unit for selecting interface unit with the least accommodating number based on the accommodating number information stored in the storing unit when the telephone terminal requests connection, and accommodating unit for accommodating the telephone terminal which has requested connection in the interface unit selected by the selecting unit.

FIG. 1 is a schematic block diagram of the structure of the system applied to the pushbutton telephone equipment related to the present invention.

The system has e.g., a local area network (LAN) 20. The LAN 20 is connected to pushbutton telephone equipment 10, an Internet Protocol (IP) network 30, and a plurality of Voice-over-IP telephone terminals (information terminals) 40. The VoIP telephone terminals 40 are telephone terminals realizing a call processing function and the like. The LAN 20 also connects to a personal digital assistance (PDA), personal computer (PC), and the like realizing an IP-QSIG (software-implemented VoIP telephone terminal) function via the IP network 30.

The pushbutton telephone equipment 10 has interface means (hereinafter called interface cards) exclusively for accommodating the VoIP telephone terminals 40 or IP-QSIG. For example, the pushbutton telephone equipment 10 comprises three interface cards 1, 2, and 3 (11a, 11b, and 11c). The pushbutton telephone equipment 10 also comprises control means 12 including analyzing means for determining the accommodating state of the terminals connected to the interface cards 1, 2, and 3 (11a, 11b, and 11c), and a database 13 for storing the accommodating state of the VoIP telephone terminals 40 and IP-QSIG determined by the analyzing means as accommodating number information.

Next, the accommodating method of the telephone terminals applied to the pushbutton telephone equipment of the present invention will be explained.

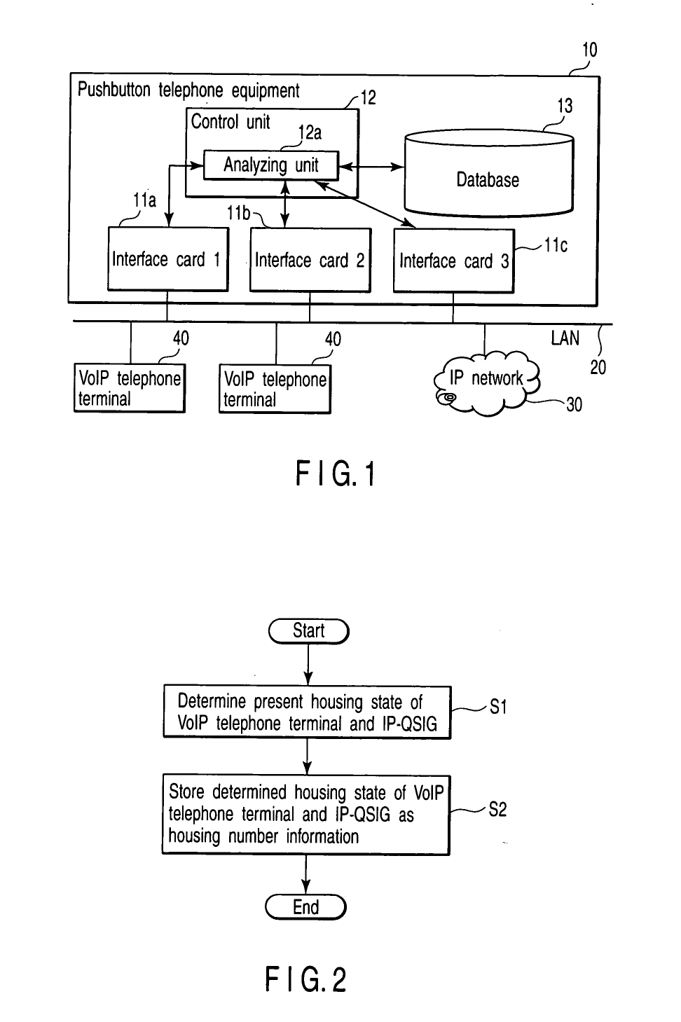

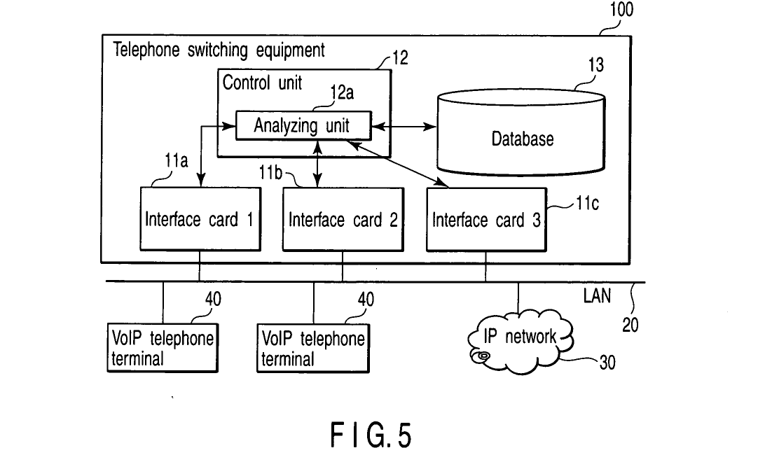

FIG. 2 is a flowchart showing the procedure of analyzing the accommodating state in the interface card of the pushbutton telephone equipment. FIG. 4 is a diagram showing the priority of the interface card and the analysis results of the accommodating state which are stored in the database 13 of the pushbutton telephone equipment 10. The number “1” has been assigned to the interface card 1 (11a) as the interface card number; the number “2”, to the interface card 2 (11b); and the number “3”, to the interface card 3 (11c).

The priorities of the interface cards are set and stored beforehand as priority information in the database 13 of the pushbutton telephone equipment 10. For example, the priority is set to medium in the interface card 1 (11a), high in the interface card 2 (11b), and low in the interface card 3 (11c). (Refer to the column “Priority for Automatic Accommodating Selection” of FIG. 4.) The priority becomes higher in the order of low<medium<high.

The total of the maximum numbers of VoIP telephone terminals and IP-QSIG which can be accommodated are set and stored beforehand as the maximum accommodating capacity. For example, the maximum accommodating capacity of each interface card 1, 2, and 3 (11a, 11b, and 11c) is set to “16”. (Refer to the column “Maximum Accommodating Capacity” of FIG. 4.)

As shown in FIG. 2, the analyzing means 12a in the control means 12 of the pushbutton telephone equipment 10 analyses the accommodating state of each interface card of the pushbutton telephone equipment 10 (step S1 of FIG. 2). At this time, the accommodating state of the VoIP telephone terminals 40 and the IP-QSIG in the interface cards is analyzed. For example, the accommodating number “1” of IP-QSIG corresponds to the accommodating number “8” (equivalent to 8 ports) of the VoIP telephone terminals.

The analyzing means 12a stores the determined accommodating state in the database 13 of the pushbutton telephone equipment 10 as accommodating number information (step S2 of FIG. 2).

For example, if in the analysis result, the accommodating number of VoIP telephone terminals in the interface card 1 (11a) is “9” and the accommodating number of IP-QSIG is “0” (refer to the columns “Present Accommodating Number of VoIP Telephone Terminals” and “Present Accommodating Number of IP-QSIG” of FIG. 4), the total of the accommodating numbers of VoIP telephone terminals and IP-QSIG will be 9+0=9. If the accommodating number of VoIP telephone terminals in the interface card 2 (11b) is “0” and the accommodating number of IP-QSIG is “1 (8 ports)”, the total of the accommodating numbers of VoIP telephone terminals and IP-QSIG will be 0+8=8. If the accommodating number of VoIP telephone terminals in the interface card 3 (11c) is “8” and the accommodating number of IP-QSIG is “0”, the total of the accommodating numbers of VoIP telephone terminals and IP-QSIG is 8+0=8.

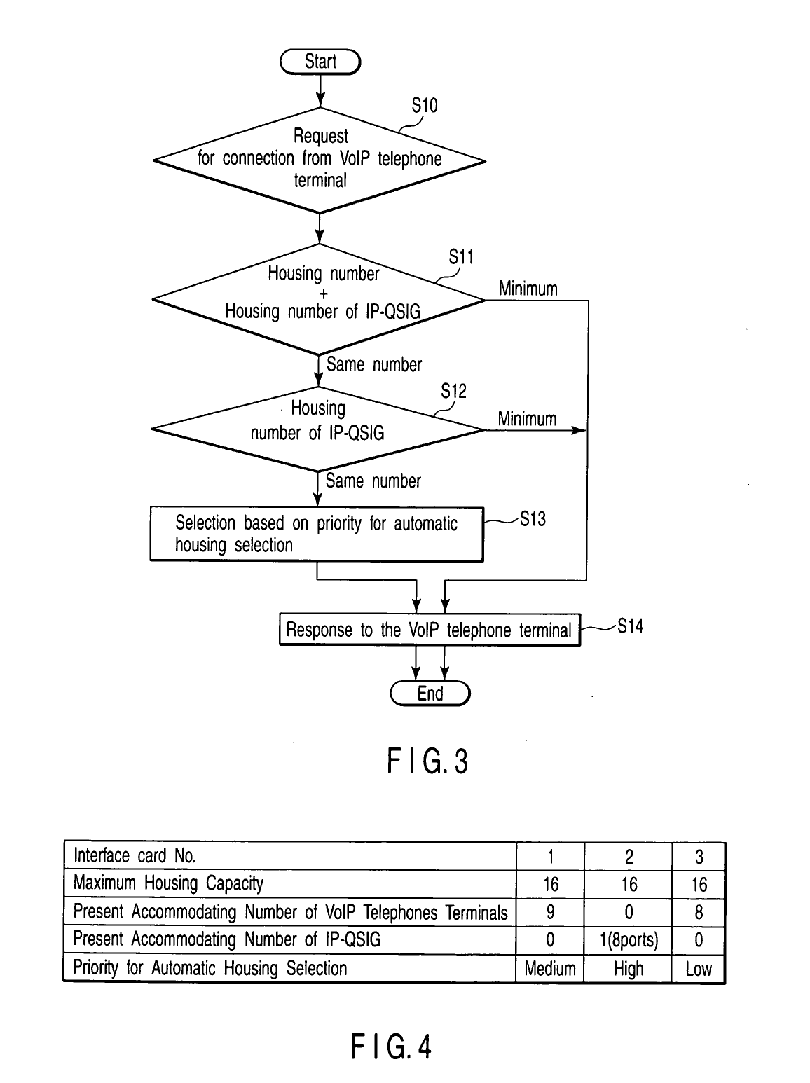

FIG. 3 is a flowchart showing the procedure of accommodating the VoIP telephone terminal 40 in the pushbutton telephone equipment when the VoIP telephone terminal 40 requests connection.

The control means 12 of the pushbutton telephone equipment 10 monitors whether the VoIP telephone terminals 40 request connection (step S10 of FIG. 3). When the control means 12 judges that the VoIP telephone terminals 40 has requested connection (YES in step S10 of FIG. 3), the total of the accommodating numbers of VoIP telephone terminals and IP-QSIG is calculated for each interface card to select the interface card of the minimum total based on the accommodating number information stored in the database 13 of the pushbutton telephone equipment 10 (step S11 of FIG. 3). In S11, if the total of the accommodating numbers of VoIP telephone terminals and IP-QSIG is calculated, and one interface card having the minimum total is determined, the control means 12 responds to the VoIP telephone terminal which has requested connection, and accommodates the VoIP telephone terminal 40 in the selected interface card (step S14 of FIG. 3).

However, in step S11, if the total of the accommodating numbers of VoIP telephone terminals and IP-QSIG is calculated, and there are at least two interface cards having the same minimum total, the interface card having the smaller accommodating number of IP-QSIG is selected (step S12 of FIG. 3). In step S12, if one interface card having the minimum accommodating number of IP-QSIG is determined, the control means 12 responds to the VoIP telephone terminal which has requested connection, and accommodates the VoIP telephone terminal 40 in the selected interface card (step S14 of FIG. 3).

In step S12, if there are at least two interface cards which have the same minimum accommodating number of IP-QSIG, the interface card having the highest priority for automatic accommodating selection is selected (step S13 of FIG. 3). Then, the control means 12 responds to the VoIP telephone terminal which has requested connection, and accommodates the VoIP telephone terminal 40 in the selected interface card (step S14 of FIG. 3).

Next, updating of the priority information, priority for automatic accommodating selection (refer to FIG. 4) when the analyzing means 12a in the control means 12 of the pushbutton telephone equipment 10 analyzes the accommodating state of the interface cards (step S1 of FIG. 2) will be explained.

The analyzing means 12a sets the priority information in the interface card accommodating the IP-QSIG low based on the accommodating number information of VoIP telephone terminals and IP-QSIG. For example, the analyzing means 12a updates the priority information of the interface card 2 (11b) in which the accommodating number of IP-QSIG is “1” so as to lower the priority for automatic accommodating selection from high to medium during analysis. At this time, the priority for automatic accommodating selection is updated so as to be different in all interface cards (e.g., avoiding setting the priority for automatic accommodating selection of two interface cards to low, and the like).

The following are other embodiments. The priority information in the interface card accommodating IP-QSIG is set lower than the priority information in the interface card which does not accommodate IP-QSIG. For example, the analyzing means 12a updates the priority information of the interface card 2 (11b) in which the accommodating number of IP-QSIG is “1” so as to lower the priority for automatic accommodating selection from high to low during analysis, and updates the priority for automatic accommodating selection in the interface card 3 (11c) in which the accommodating number of IP-QSIG is “0” so as to raise the priority from low to high.

In such a case, the interface cards in which the accommodating number of IP-QSIG is “0” are the interface card 1 (11a) and the interface card 3 (11c). Although the priority for automatic accommodating selection in the interface card 3 (11c) in which the accommodating number of VoIP telephone terminals has been updated, the priority for automatic accommodating selection can be arbitrarily changed. Likewise, the priority for automatic accommodating selection is updated so as to be different in all interface cards (e.g., avoiding setting the priority for automatic accommodating selection of two interface cards to high).

In the above way, it is possible to use pushbutton telephone equipment to independently manage the number of telephone terminals accommodated in each interface card in pushbutton telephone equipment and telephone switching equipment and spread the load when accommodating telephone terminals. It is also possible to lower the priority in an interface card accommodating IP-QSIG so as to lower the concentration of the load in the interface card which has a relatively high load.

### OTHER EMBODIMENTS

FIG. 5 is a schematic block diagram showing the structure of the system applied to the telephone switching equipment related to the present invention. The structure of telephone switching equipment 100 is the same as that of the aforementioned pushbutton telephone equipment 10 shown in FIG. 1. The same effect and advantage as in the pushbutton telephone equipment 10 can be provided when the pushbutton telephone equipment 10 of FIG. 1 is changed to the telephone switching equipment 100.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the invention.

What is claimed is:

1. A pushbutton telephone apparatus comprising a plurality of interface units for accommodating telephone terminals, wherein the pushbutton telephone apparatus is characterized in comprising:
an analyzing unit for analyzing an accommodating state in each of the plurality of interface units;
a storing unit for storing, as accommodating number information, the accommodating state analyzed by the analyzing unit;
a selecting unit for selecting an interface unit having the smallest accommodating number based on the accommodating number information stored in the storing unit; and
an accommodating unit for accommodating the telephone terminals requesting connection in the interface unit selected by the selecting unit.

2. The pushbutton telephone apparatus according to claim 1, wherein the storing unit sets, as priority information, priorities for selecting the plurality of interface units, and the selecting unit selects the interface unit to accommodate the telephone terminal based on the priority information.

3. The pushbutton telephone apparatus according to claim 1, wherein the telephone terminals are VoIP telephone terminals.

4. The pushbutton telephone apparatus according to claim 1, wherein the accommodating number information is a total of the accommodating numbers of VoIP telephone terminals and IP-QSIG.

5. The pushbutton telephone apparatus according to claim 2, wherein the analyzing unit sets the priority information in an interface unit accommodating IP-QSIG lower than those of the other interface units based on the accommodating number information.

6. The pushbutton telephone apparatus according to claim 3, wherein the analyzing unit sets the priority information in an interface unit accommodating IP-QSIG lower than those of the other interface units based on the accommodating number information.

7. The pushbutton telephone apparatus according to claim 5, wherein the analyzing unit sets the priority information in an interface unit accommodating IP-QSIG lower than those of the interface units without IP-QSIG based on the accommodating number information.

8. A pushbutton telephone apparatus comprising a plurality of interface units for accommodating VoIP telephone terminals and IP-QSIG, wherein the pushbutton telephone equipment is characterized in comprising:
a first storing unit for setting priority in each of the plurality of interface units and storing the priority as priority information;
an analyzing unit for determining an accommodating state in each of the plurality of interface units;
a second storing unit for storing the accommodating state determined by the analyzing unit as accommodating number information of the VoIP telephone terminals and IP-QSIG;
a first selecting unit for, when the VoIP telephone terminal requests connection, selecting an interface unit having the smallest total of the accommodating numbers of the VoIP telephone terminals and IP-QSIG based on the accommodating number information stored in the second storing unit;
a second selecting unit for, when at least two interface units are selected by the first selecting unit, selecting an interface unit having the smallest accommodating number of IP-QSIG;
a third selecting unit for, when at least two interface units are selected by the second selecting unit, selecting an interface unit having higher priority based on the priority information stored in the first storing unit; and
an accommodating unit for accommodating the VoIP telephone terminal requesting connection in the interface unit selected by the third selecting unit.

9. A telephone switching apparatus comprising a plurality of interface units for accommodating telephone terminals, wherein the pushbutton telephone apparatus is characterized in comprising:
an analyzing unit for determining an accommodating state in each of the plurality of interface units;
a storing unit for storing, as accommodating number information, the accommodating state determined by the analyzing unit;
a selecting unit for selecting an interface unit having the smallest accommodating number based on the accommodating number information stored in the storing unit; and
an accommodating unit for accommodating the telephone terminals requesting connection in the interface unit selected by the selecting unit.

10. The telephone switching apparatus according to claim 9, wherein the storing unit sets, as priority information, priorities for selecting the plurality of interface units, and the selecting unit selects the interface unit to accommodate the telephone terminal based on the priority information.

11. The telephone switching apparatus according to claim 9, wherein the telephone terminals are VoIP telephone terminals.

12. A telephone switching apparatus comprising a plurality of interface units for accommodating VoIP telephone terminals and IP-QSIG, wherein the pushbutton telephone equipment is characterized in comprising:
a first storing unit for setting priority in each of the plurality of interface units and storing the priority as priority information;
an analyzing unit for determining an accommodating state in each of the plurality of interface units;
a second storing unit for storing the accommodating state determined by the analyzing unit as accommodating number information of the VoIP telephone terminals and IP-QSIG;
a first selecting unit for, when the VoIP telephone terminal requests connection, selecting an interface unit having the smallest total of the accommodating numbers of the VoIP telephone terminals and IP-QSIG based on the accommodating number information stored in the second storing unit;
a second selecting unit for, when at least two interface units are selected by the first selecting unit, selecting an interface unit having the smallest accommodating number of IP-QSIG;
a third selecting unit for, when at least two interface units are selected by the second selecting unit, selecting an interface unit having higher priority based on the priority information stored in the first storing unit; and
an accommodating unit for accommodating the VoIP telephone terminal requesting connection in the interface unit selected by the third selecting unit.

13. An accommodating method of an apparatus comprising a plurality of interface units for accommodating VoIP telephone terminals and IP-QSIG, wherein the method is characterized in comprising:
analyzing an accommodating state in each of the plurality of interface units;
storing the accommodating states determined in the analyzing as accommodating number information of the VoIP telephone terminals and IP-QSIG;
first selecting an interface unit having the smallest total of the accommodating numbers of the VoIP telephone terminals and IP-QSIG based on the accommodating number information stored in the storing unit when the VoIP telephone terminal requests connection;
second selecting an interface unit having the smallest accommodating number of IP-QSIG when at least two interface units are selected in the first selecting;
third selecting an interface unit having higher priority based on the priority information stored in the storing unit when at least two interface units are selected in the second selecting, wherein the priority is set in advance in the storing unit as the priority information for each of the plurality of interface units; and
accommodating the VoIP telephone terminal requesting connection in one interface unit specified among the interface units selected in the first through third selecting.
